(19) United States
(12) Patent Application Publication
(10) Pub. No.: US 2015/0122472 A1
(43) Pub. Date: May 7, 2015

(54) VEHICLE AIR-CONDITIONING DEVICE

(71) Applicant: DENSO CORPORATION, Kariya-city, Aichi-pref (JP)

(72) Inventors: Terukazu Higuchi, Okazaki-city (JP); Yoshinori Yanagimachi, Takahama-city (JP); Yasuhiro Yokoo, Kariya-city (JP)

(21) Appl. No.: 14/411,149

(22) PCT Filed: May 21, 2013
(86) PCT No.: PCT/JP2013/003221

§ 371 Date: Dec. 24, 2014

(30) Foreign Application Priority Data
Jun. 29, 2012 (JP) 2012-146540

(51) Int. Cl. B60H 1/00; F25B 49/02

(52) U.S. Cl. CPC B60H 1/00735; F25B 49/022; B60H 1/00007
USPC 165/202; 62/180

(57) ABSTRACT

A vehicle air-conditioning device includes a blower which blows air to a vehicle cabin through blowout openings, a refrigeration circuit through which refrigerant is circulated by an electric compressor, an interior heat exchanger disposed in the refrigeration circuit and exchanging heat between the refrigerant and a blown air, which is air that is blown by the blower, an interior/exterior air adjustment device adjusting a ratio of interior air and exterior air contained in the blown air, and a first blowing control portion controlling the electric compressor to stop, controlling the blower to operate, and controlling the interior/exterior air adjustment device such that air that is blown into the vehicle cabin includes at least exterior air, when a temperature difference between a target temperature Tao of air that is blown through the blowout opening and an exterior air temperature Tam is less than a predetermined value. In this case, when the temperature Tao is close to the temperature Tam, the electric compressor is stopped and air including exterior air is blown by the blower. Thus, a reduction in electric-power consumption can be achieved and a temperature of the air can get closer to Tao.

### CROSS-REFERENCE TO RELATED APPLICATIONS

The present application is based on Japanese patent application No. 2012-146540 filed on Jun. 29, 2012, the content of which is incorporated herein by reference.

### TECHNICAL FIELD

The present disclosure relates to a vehicle air-conditioning device having a refrigeration circuit which circulates refrigerant using an electric compressor.

### BACKGROUND ART

Intermediary-stage control which is performed in an intermediary-stage cooling operation in a state where a target temperature (Tao) of air blown into a vehicle cabin is slightly lower than an exterior air temperature (Tam), or which is performed in an intermediary-stage heating operation in a state where Tao is slightly higher than Tam has been disclosed in Patent Literature 1.

In the intermediary-stage control, both the cooling of air using an evaporator of a refrigeration circuit and the heating of air using a heater are performed. The temperature of the blown air is adjusted to Tao by adjusting degree of heating by the heater using an air-mix door.

In other words, the discharge amount of the electric compressor has the minimum value. Thus, in the intermediary stage in which a temperature difference between Tao and Tam is small, accurate temperature adjustment of the blown air is difficult to be performed by reducing the discharge amount of the electric compressor. For this reason, the intermediary stage control described above adjusts the temperature using the air-mix door in such a manner that cooling is performed even in a heating operation and heating is performed even in a cooling operation.

### PRIOR ART LITERATURE

### Patent Literature

Patent Literature 1: JP 2009-202736 A

### SUMMARY OF THE INVENTION

However, performing both the cooling and the heating of air at the same time leads to energy loss and the intermediary-stage control of the related art has room for improvement, in terms of achieving a reduction in electric-power consumption of the electric compressor.

It is an object of the present disclosure to provide a vehicle air-conditioning device capable of achieving a reduction in electric-power consumption of an electric compressor.

In an aspect of the present disclosure, a vehicle air-conditioning device including: a blower blowing air into a vehicle cabin through blowout openings; a refrigeration circuit through which refrigerant is circulated by an electric compressor; an interior heat exchanger disposed in the refrigeration circuit and exchanging heat between the refrigerant and a blown air, which is air that is blown by the blower; an interior/exterior air adjustment device adjusting a ratio of interior air and exterior air contained within the blown air; and a first blowing control portion controlling the electric compressor to stop, controlling the blower to operate, and controlling the interior/exterior air adjustment device such that air that is blown into the vehicle cabin includes at least exterior air, when a temperature difference between a target temperature of air that is blown through the blowout opening and an exterior air temperature is less than a predetermined value.

In this case, when a temperature Tao is close to a temperature Tam, the electric compressor is stopped and air including exterior air is blown by the blower. Thus, a reduction in electric-power consumption can be achieved and the temperature of the blown air can get closer to Tao. In short, the disclosure places a focus on an assumption that, even when the temperature of the blown air is somewhat deviated from Tao, the comfort level of a user is not significantly deteriorated and the disclosure gives more priority to a reduction in electric-power consumption of the electric compressor than high accuracy for adjusting the temperature of the blown air to Tao.

### BRIEF DESCRIPTION OF THE DRAWINGS

FIG. 1 is a schematic view illustrating an electric vehicle system according to a first embodiment of the present disclosure.

FIG. 2 is a view illustrating an operation mode range of the first embodiment.

FIG. 3 is a flowchart illustrating air-conditioning control of the first embodiment.

FIG. 4 is a flowchart illustrating air-conditioning control according to a second embodiment of the present disclosure.

FIG. 5 is a schematic view illustrating an electric vehicle system according to a third embodiment of the present disclosure.

### EMBODIMENTS FOR CARRYING OUT INVENTION

Hereinafter, a plurality of embodiments for embodying the present disclosure disclosed below will be described with reference to the accompanying drawings. The same reference numerals are given to parts of each embodiment, which correspond to parts described in the preceding embodiment, and the description thereof will not be repeated in some cases. When only a part of the configuration is described in each embodiment, the configurations of other preceding described embodiments can be applied to the remaining parts of the configuration. Furthermore, in the subsequent embodiment, the reference numerals of which only the digits in the hundreds column are different from those of the preceding embodiment are given to parts corresponding to parts described in the preceding embodiment so as to illustrate the corresponding relationship therebetween and the description will not be repeated in some cases. The combinations of the parts are not limited to those specifically illustrated in each embodiment. Even when there is no description, the embodiments can also be used in partial combination as long as there is not a problem in combination.

### First Embodiment

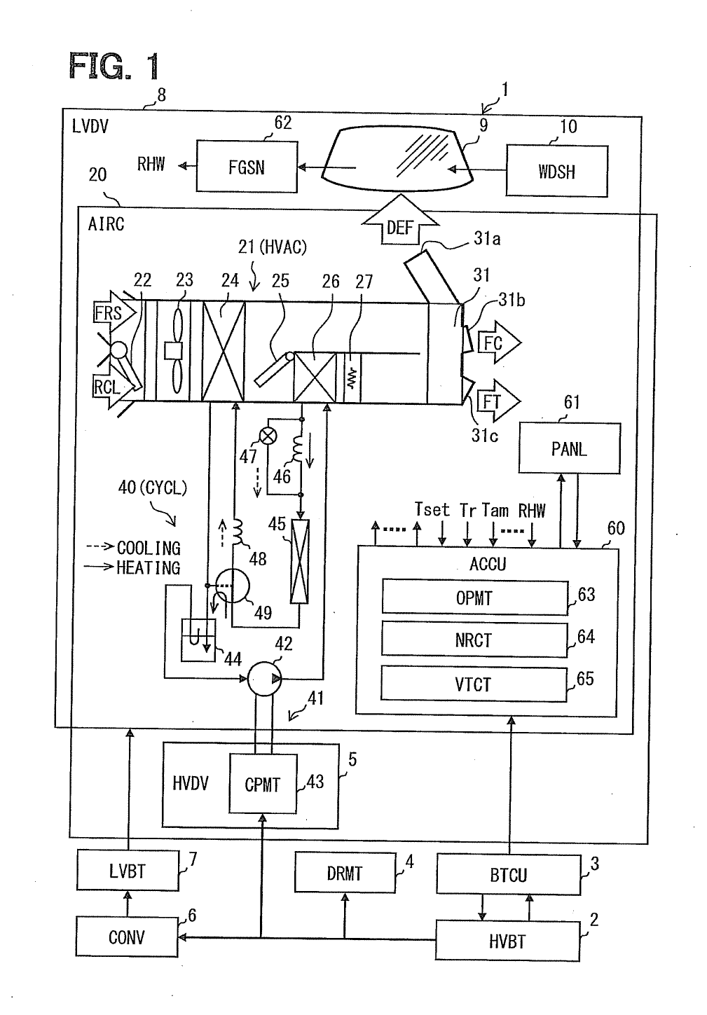

An electric vehicle system 1 illustrated in FIG. 1 is mounted on an electric vehicle. The electric vehicle is a vehicle which includes an electric driving system having both a storage battery and an electric motor. The electric vehicle may be a road traveling vehicle, a vessel, or an aircraft. A so-called electric car having only an electric driving system can be provided as the electric vehicle. A hybrid vehicle which has, in addition to an electric driving system, an internal combustion engine system having both a fuel tank and an internal combustion engine can be provided as the electric vehicle.

The electric vehicle system 1 has a high voltage battery (HVBT) 2. The high voltage battery 2 is a secondary battery. A lithium-ion battery or the like can be provided as the high voltage battery 2. The high voltage battery 2 supplies relatively high voltage of several hundred volts. The high voltage battery 2 is charged through a stationary wide-area electric power grid or a generator mounted on a vehicle. The electric vehicle system 1 has a battery control unit (BTCU) 3. The battery control unit 3 monitors charging/discharging of the high voltage battery 2 and controls charging/discharging thereof.

The electric vehicle system 1 has an electric motor (DRMT) 4 for travel. The electric motor 4 drives a drive wheel of the electric vehicle. The high voltage battery 2 is designed to mainly supply electric-power to the electric motor 4.

The electric vehicle system 1 has a high voltage device (HVDV) 5 mounted on the electric vehicle. The high voltage device 5 does not include the electric motor 4 for travel. The high voltage device 5 is a device with a rated voltage suitable to receive electric-power from the high voltage battery 2.

The electric vehicle system 1 has a converter (CONV) 6 and a low voltage battery (LVBT) 7. The converter 6 converts the electric-power supplied from the high voltage battery 2 and supplies the converted electric-power to the low voltage battery 7. The converter 6 charges the low voltage battery 7. The converter 6 is also one of the high voltage devices 5. The low voltage battery 7 is a secondary battery of relatively low voltage. The low voltage battery 7 supplies voltage of approximately 10 volts, for example, 12 volts or 24 volts. The low voltage battery 7 is charged by the high voltage battery 2 through the converter 6.

The electric vehicle system 1 has a plurality of low voltage devices (LVDV) 8. The plurality of low voltage devices 8 are operated by a voltage lower than the voltage of the high voltage battery 2. The plurality of low voltage devices 8 are operated by the electric-power supplied from the low voltage battery 7. The plurality of low voltage devices 8 include most devices of an air conditioning system 20 described below. Only an electric compressor 41 of the air conditioning system 20 is not included in the low voltage devices 8.

The electric vehicle system 1 may have a window shield 9 of a vehicle. The window shield 9 is installed in front of a driver of a vehicle. The window shield 9 is also referred to as a windscreen.

The electric vehicle system 1 has a window heater (WDSH) 10 installed in the window shield 9. The window heater 10 is an electric heater unit which is installed in the window shield 9 and can directly heat the window shield 9. An electric heating wire laid in the window shield 9 or a transparent heating body adhering to the window shield 9 can be provided as the window heater 10. The window heater 10 is one of the low voltage devices 8 and receives the electric-power from the low voltage battery 7.

The window heater 10 is an element which can perform a heating function on the window shield 9, even when an electric compressor 41 is stopped. The window heater 10 is the only heating element capable of directly heating the window shield 9. The window heater 10 directly suppresses fogging of the window shield 9 by increasing a temperature of the window shield 9.

The electric vehicle system 1 has an air conditioning system (AIRC) 20 for a vehicle. The window heater 10 can be conceived as a configuration element of the air conditioning system 20. The air conditioning system 20 has an air conditioning unit (HVAC) 21. The air conditioning unit 21 is also referred to as a Heating Ventilating and Air-Conditioning (HVAC) unit. The air conditioning unit 21 has a plurality of elements 22 to 31 to perform heating, air-blowing, and air-conditioning of a vehicle cabin of the electric vehicle. The air conditioning unit 21 provides a duct through which air can flow to the vehicle cabin.

An interior air/exterior air switching device 22 (an interior/exterior air adjustment device) selects air introduced into the air conditioning unit 21. The interior air/exterior air switching device 22 can select interior air (RCL) or exterior air (FRS). The interior air/exterior air switching device 22 may continuously or stepwisely adjust a ratio between interior air and exterior air. The interior air/exterior air switching device 22 can be provided by an interior air flow passage, an exterior air flow passage, and a switching damper mechanism.

An opening is formed in a switching damper mechanism, and thus it is not possible to completely close either one of the interior air flow passage or the exterior air flow passage. In other words, exterior air is mixed, through the opening, even in the interior air mode, and interior air is mixed, through the opening, even in the exterior air mode.

The interior air is air circulately introduced from the vehicle cabin. The exterior air is air newly introduced from the outside. When heating of the vehicle cabin is required, a temperature of the exterior air is usually lower than the temperature of the interior air. Accordingly, the humidity of the exterior air is usually lower than the humidity of the interior air. Furthermore, in many cases, the humidity of the exterior air is lower than the humidity of the interior air because of a user in the vehicle cabin. Therefore, the exterior air can be used to lower the humidity of the air blown from the air conditioning unit 21 or to lower the humidity of the vehicle cabin.

The interior air/exterior air switching device 22 switches a mode between an exterior air mode in which the exterior air is introduced from the outside and an interior air mode in which the interior air of the vehicle cabin circulates. When the interior air/exterior air switching device 22 selects the exterior air mode, the interior air/exterior air switching device 22 lowers the humidity of the vehicle cabin. The interior air/exterior air switching device 22 is one of the humidity lowering devices which lowers the humidity of the vehicle cabin even when the electric compressor 41 is stopped. The interior air/exterior air switching device 22 indirectly suppresses fogging of the window shield 9 by decreasing the humidity of the vehicle cabin.

A blower 23 is located inside the air conditioning unit 21 and generates an air flow flowing to the vehicle cabin. The blower 23 is also referred to as a blower fan.

A cooling heat exchanger 24 (an interior heat exchanger) is a part of a refrigeration circuit 40 described below. The cooling heat exchanger 24 is an interior heat exchanger of the refrigeration circuit 40. An evaporator of the refrigeration circuit 40 is provided as the cooling heat exchanger 24. The cooling heat exchanger 24 performs cooling of the air flowing through the air conditioning unit 21, using refrigerant. The refrigerant which is in a low-temperature and low-pressure state and flows in the refrigeration circuit 40 flows into the cooling heat exchanger 24. The cooling heat exchanger 24 is disposed in a state where the cooling heat exchanger 24 cools the entirety of the air flowing through the air conditioning unit 21.

The cooling heat exchanger 24 can perform the cooling of air, only in a state where electric compressor 41 of the high voltage device 5 is operated. Accordingly, the cooling heat exchanger 24 is an air cooling element which does not perform an air cooling function in a state where the electric compressor 41 is stopped. The cooling heat exchanger 24 performs a cooling function, only in a state where the refrigeration circuit 40 performs a cooling operation. When the cooling heat exchanger 24 performs the cooling function, dew condensation water is generated on a surface of the cooling heat exchanger 24. When the cooling heat exchanger 24 does not perform the cooling function, the dew condensation water is evaporated, and then is blown into the vehicle cabin. The cooling heat exchanger 24 is the sole air cooling element in the air conditioning system 20.

An air mix damper 25 adjusts the temperature of blown air, in such a manner that the air mix damper 25 adjusts a ratio between hot air and cold air in the air conditioning unit 21. The air mix damper 25 adjusts a ratio between an amount of air passing through an air heating element described below and an amount of air bypassing the air heating element. The air mix damper 25 is provided as a temperature regulation member that adjusts a temperature of the blown air.

A heating heat exchanger 26 (an interior heat exchanger) is a part of the refrigeration circuit 40 described below. The heating heat exchanger 26 is an interior heat exchanger of the refrigeration circuit 40. A condenser of the refrigeration circuit 40 is provided as the heating heat exchanger 26. The heating heat exchanger 26 performs, using refrigerant, the heating of air flowing through the air conditioning unit 21. Refrigerant in a high-temperature and high-pressure state flows through the heating heat exchanger 26. The heating heat exchanger 26 is disposed in a state where the heating heat exchanger 26 heats at least a portion of air flowing through the air conditioning unit 21. The heating heat exchanger 26 is one of air heating elements.

The heating heat exchanger 26 can perform the heating of air, only in a state where the electric compressor 41 of the high voltage device 5 is operated. Accordingly, the heating heat exchanger 26 is an air heating element which does not perform a heating function on the window shield 9, in a state where the electric compressor 41 is stopped.

An electric heater 27 heats, using electric-power, air that flows through the air conditioning unit 21 and is blown into the vehicle cabin. The electric heater 27 is disposed in a state where the electric heater 27 heats at least a portion of air flowing through the air conditioning unit 21. The electric heater 27 is provided by an electric heater element. The electric heater is provided by a heater element which is referred to as a Positive Temperature Coefficient (PTC) heater. The electric heater 27 is one of the low voltage devices 8. The electric heater 27 receives the electric-power from the low voltage battery 7.

The electric heater 27 is one of the air heating elements, which heats air that is to be blown into the vehicle cabin of the electric vehicle and indirectly heats the window shield 9. The electric heater 27 is an air heating element which can perform the heating function on the window shield 9, even in a state where the electric compressor 41 is stopped. The electric heater 27 is one of the heating elements, which can indirectly heat the window shield 9. The electric heater 27 indirectly suppresses fogging of the window shield 9 by increasing a temperature of the window shield 9.

An air-blowing mode switch device 31 switches an air-blowing mode of air from the air conditioning unit 21 into the vehicle cabin. The air-blowing mode switch device 31 provides a plurality of air-blowing modes by selectively opening/closing a plurality of outlet ports 31a, 31b, and 31c. The air-blowing mode switch device 31 may have a plurality of air flow passages and a plurality of damper devices which open/close the air flow passages. The air-blowing mode switch device 31 provides, for example, a defroster outlet port (DEF) 31a, a face outlet port (FC) 31b, and a foot outlet port (FT) 31c. The air-blowing mode switch device 31 provides a plurality of air-blowing modes using the plurality of outlet ports 31a, 31b, and 31c in combination. In the defroster air-blowing mode, the air flowing through the air conditioning unit 21 is blown from the defroster outlet port 31a toward mainly the window shield 9. In the face air-blowing mode, the air flowing through the air conditioning unit 21 is blown from the face outlet port 31b toward mainly the upper body of a passenger. In the foot air-blowing mode, the air flowing through the air conditioning unit 21 is blown from the foot outlet port 31c toward mainly the feet of a passenger.

The air conditioning system 20 has the refrigeration circuit (CYCL) 40. The cooling heat exchanger 24 is provided as an interior heat exchanger for cooling of the refrigeration circuit 40. The heating heat exchanger 26 is provided as an interior heat exchanger for heating of the refrigeration circuit 40. The refrigeration circuit 40 has at least the cooling heat exchanger 24 so as to cool air. The refrigeration circuit 40 of the embodiment is a heat pump cycle capable of performing both the cooling and heating of air.

The refrigeration circuit 40 has the electric compressor 41. The electric compressor 41 has a compressor 42 and an electric motor (CPMT) 43. A rotation shaft of the compressor 42 is linked to a rotation shaft of the electric motor 43. The electric motor 43 drives the compressor 42. The electric motor 43 drives the compressor 42, and thus the compressor 42 sucks in refrigerant and compresses the sucked in refrigerant, then discharges the compressed refrigerant. The electric motor 43 is one of the high voltage devices 5. The electric motor 43 rotates by receiving the electric-power of high voltage from the high voltage battery 2. The electric motor 43, which is one of the electric loads, mounted on the electric vehicle is one of the loads of which the electric power consumption is large. In an example illustrated in drawings, the electric motor 43 has an electric load of which the electric power consumption is large, secondary to the electric motor 4 for travel. Accordingly, a reduction in the remaining power of the high voltage battery 2 can be suppressed by preventing the electric-power from being supplied to the electric motor 43. A travel distance of the electric vehicle can be extended by preventing the electric-power from being supplied to the electric motor 43.

A gas-liquid separator 44 is provided on an intake side of the compressor 42. The compressor 42 sucks the refrigerant from the gas-liquid separator 44. The heating heat exchanger 26 is provided on a discharge side of the compressor 42. The compressor 42 supplies the refrigerant in a high-temperature and high-pressure state to the heating heat exchanger 26. The heating heat exchanger 26 functions as a radiator or a condenser in the refrigeration circuit 40.

The refrigeration circuit 40 has an exterior heat exchanger 45. The exterior heat exchanger 45 is installed in the outside of the electric vehicle and can perform heat-exchange with exterior air. The exterior heat exchanger 45 can function as an evaporator or a radiator. The exterior heat exchanger 45 is provided in a portion between the heating heat exchanger 26 and the cooling heat exchanger 24. The refrigerant flowing through the heating heat exchanger 26 is supplied into the exterior heat exchanger 45. The refrigerant flowing through the exterior heat exchanger 45 can be supplied into the cooling heat exchanger 24.

A parallel circuit including a decompressor 46 and an on/off valve 47 is disposed in a portion between the heating heat exchanger 26 and the exterior heat exchanger 45. The parallel circuit provides a portion of a switch device in the refrigeration circuit 40. An expansion valve or a capillary tube can be provided as the decompressor 46. The on/off valve 47 is a solenoid valve having an electromagnetic actuator. The refrigerant flowing through the heating heat exchanger 26 passes through the decompressor 46 or the on/off valve 47, and then flows into the exterior heat exchanger 45. When the on/off valve 47 is opened, the refrigerant flows through the on/off valve 47. Accordingly, the refrigerant flowing through the heating heat exchanger 26 maintains the high-temperature and high-pressure and flows into the exterior heat exchanger 45. When the on/off valve 47 is opened, the exterior heat exchanger 45 functions as a radiator.

A series circuit including a decompressor 48 and a switch valve 49 is disposed in a portion between the exterior heat exchanger 45 and the cooling heat exchanger 24. The series circuit is provided as a portion of the switch device in the refrigeration circuit 40. An expansion valve or a capillary tube can be provided as the decompressor 48. The switch valve 49 is a solenoid valve having an electromagnetic actuator. The switch valve 49 is a three-port switch valve. The switch valve 49 has a common port communicating with the exterior heat exchanger 45, a first port communicating with the decompressor 48, and a second port communicating with the gas-liquid separator 44. The second port is provided as a bypass flow passage through which the refrigerant flowing through the exterior heat exchanger 45 can flow into the gas-liquid separator 44, without passing through the decompressor 48 and the cooling heat exchanger 24. The switch valve 49 can selectively provide a state in which the common port communicates with the first port and a state in which the common port communicates with the second port. When the switch valve 49 causes the common port to communicate with the first port, the refrigerant flows through the decompressor 48 and the cooling heat exchanger 24. Accordingly, the refrigerant flowing through the exterior heat exchanger 45 is decompressed by the decompressor 48, and then flows through the cooling heat exchanger 24. In this case, the refrigerant in the low-temperature and low-pressure state performs cooling of the air in the air conditioning unit 21 by evaporating the refrigerant in the cooling heat exchanger 24. Thus, when the switch valve 49 causes the refrigerant to flow to the decompressor 48, the cooling heat exchanger 24 functions as an evaporator. When the switch valve 49 causes the common port to communicate with the second port, the refrigerant flows in a state where the refrigerant bypasses the cooling heat exchanger 24. Accordingly, the refrigerant flowing through the exterior heat exchanger 45 passes through the gas-liquid separator 44 and flows into the compressor 42 in a suction manner. In this case, only the heating heat exchanger 26 functions.

The on/off valve 47 and the switch valve 49 are controlled in association with each other. When the on/off valve 47 is opened, the switch valve 49 causes the refrigerant to flow to both the decompressor 49 and the cooling heat exchanger 24. In this case, the cooling heat exchanger 24 functions as an evaporator, and thus performs cooling of air flowing through the air conditioning unit 21. Furthermore, the heating heat exchanger 26 functions as a radiator, and thus performs heating of the air flowing through the air conditioning unit 21. When the on/off valve 47 is closed, the switch valve 49 causes the refrigerant to flow in a state where the refrigerant bypasses both the decompressor 49 and the cooling heat exchanger 24. In this case, the cooling heat exchanger 24 is disabled and the heating heat exchanger 26 functions as a radiator, and thus air flowing through the air conditioning unit 21 is heated.

The air conditioning system 20 has an air conditioning control unit (ACCU) 60. The air conditioning control unit 60 constitutes a control system for controlling the air conditioning system 20. The air conditioning control unit 60 receives signals from a plurality of input devices including a plurality of sensors, and controls a plurality of actuators in accordance with the signals and control programs set in advance.

The air conditioning control unit 60 controls, for example, a plurality of actuators related to a temperature control of the vehicle cabin. The air conditioning control unit 60 can control the air mix damper 25 and the blower 23 such that a room temperature Tr, that is, a temperature of the vehicle cabin, is matched with a setting temperature Tset. Furthermore, the air conditioning control unit 60 can operate the electric compressor 41 within a range of an amount of available electric-power which is allowed by the battery control unit 3. The air conditioning control unit 60 can control the temperatures of both the cooling heat exchanger 24 and the heating heat exchanger 26 to be in a predetermined temperature state by controlling a plurality of valves 47, 49. Furthermore, the air conditioning control unit 60 controls a plurality of actuators which directly/indirectly relate to fogging suppression of the window shield 9.

The air conditioning system 20 has an operation panel (PANL) 61. The operation panel 61 has a plurality of switches for operating the air conditioning system 20 and a display device which shows an operating state of the air conditioning system 20. Thus, the operation panel 61 is one of the input devices and, also, is one of the output devices of the control system. The plurality of switches may include a setting unit for setting the setting temperature Tset, an indoor/exterior air switch for selecting the interior air or the exterior air, an air volume switch for setting an air volume, an air conditioner switch for selecting cooling or heating, and an air-blowing mode switch for selecting the air-blowing mode. The air-blowing mode switch can include a DEF switch for selecting a defroster air-blowing mode through the defroster outlet port 31a.

The air conditioning system 20 has a plurality of sensors. The plurality of sensors include a dew condensation sensor (FGSN) 62 for detecting a relative humidity RHW of an inner-side surface of the window shield 9. The dew condensation sensor 62 is provided as a sensor for detecting fogging of the window shield 9. An output signal from the dew condensation sensor 62 indicates the relative humidity RHW at a temperature of the inner-side surface of the window shield 9. Thus, when the relative humidity RHW output from the dew condensation sensor 62 is greater than 100%, it is possible to say that fogging may occur on the window shield 9. On the contrary, when the relative humidity RHW output from the dew condensation sensor 62 is less than 100%, it can be determined that there is no possibility that fogging may occur on the window shield 9. In addition, when the relative humidity RHW output from the dew condensation sensor 62 is significantly greater than 100%, it can be determined that fogging highly likely occurs on the window shield 9.

The air conditioning control unit 60 receives signals from, for example, a room temperature sensor for detecting the room temperature Tr, a setting unit for setting the setting temperature Tset, and an exterior air temperature sensor for detecting an exterior air temperature Tam. The air conditioning control unit 60 may receive signals from an insolation sensor for detecting an amount of insolation and a sensor for detecting a temperature of a surface of a heat exchange fin of the cooling heat exchanger 24. The air conditioning control unit 60 may receive a signal which indicates a current operating state of the refrigeration circuit 40, that is, a signal indicates that the current operating state is in a cooling-operation state or a heating-operation state. The air conditioning control unit 60 may receive signals from a plurality of sensors which detect a pressure of the refrigerant in each portion of the refrigeration circuit 40 and/or detect the temperature of the refrigerant. The air conditioning control unit 60 may receive signals from, for example, sensors for detecting both the pressure of a high-pressure refrigerant of the refrigeration circuit 40 and the pressure of a low-pressure refrigerant.

The air conditioning control unit 60 calculates a target temperature Tao of air blown out from the blowout openings 31a, 31b, and 31c, based on the setting temperature Tset, the exterior air temperature Tam, the room temperature Tr, a signal from the dew condensation sensor 62, and the like. The target temperature Tao is set as the optimal value to match the room temperature Tr to the setting temperature Tset. Data illustrating the relationship between the setting temperature Tset, the exterior air temperature Tam, the room temperature Tr, and the optimal value of the target temperature Tao are stored in the form of a map or the like, for example, and the target temperature Tao is calculated based on the parameters Tset, Tam, and Tr while referring to the map.

The air conditioning control unit 60 has an operation mode determination portion (OPMT) 63 which determines an operation mode of the air conditioning system 20 from the cooling mode, the heating mode, and the air-blowing mode. In the heating mode, the vehicle cabin is heated in such a manner that hot air is blown out from both the foot blowout opening 31c and the defroster outlet port 31a. In the cooling mode, the vehicle cabin is cooled in such a manner that cold air is blown out from the face blowout opening 31b. In the air-blowing mode, various heaters 10, 27 and the electric compressor 41 are stopped and exterior air itself is blown out into the vehicle cabin in a state where the exterior air is not subject to heat exchange, and thus the vehicle cabin is maintained at an appropriate temperature and exterior air with relatively low humidity is introduced and blown into the vehicle cabin.

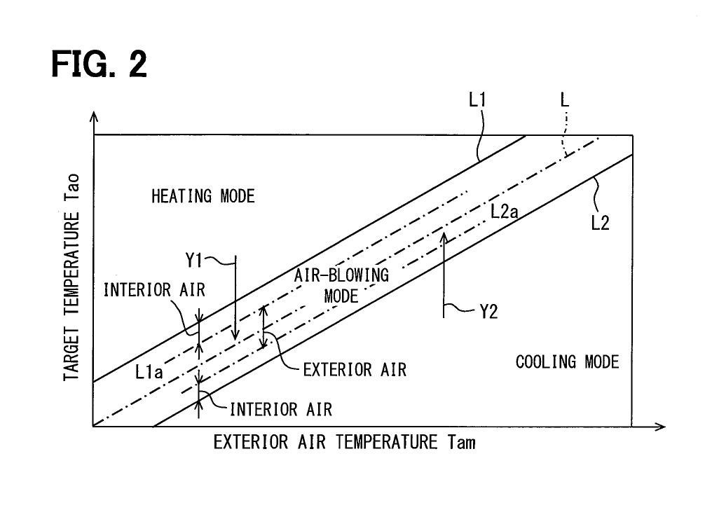

The operation mode determination portion 63 determines that the operation mode should be switched to the heating mode, the cooling mode, or the air-blowing mode, based on both the target temperature Tao and the exterior air temperature Tam. In the present embodiment, the operation mode is determined based on the map illustrated in FIG. 2.

A one dot chain line L in FIG. 2 illustrates a line (a reference line) in which the exterior air temperature Tam is matched to the target temperature Tao. A solid line L1 in the drawing illustrates a line (a heating determination line) in which the exterior air temperature Tam is lower than the target temperature Tao by a predetermined value (for example, 5° C.). A solid line L2 in the drawing illustrates a line (a cooling determination line) in which the exterior air temperature Tam is higher than the target temperature Tao by a predetermined value (for example, 5° C.). The offset of the heating determination line L1 relative to the reference line L is matched to the offset of the cooling determination line L2 relative to the reference line L.

When the exterior air temperature Tam and the target temperature Tao, both of which are obtained at the moment, are within the range (an air-blowing range) between the heating determination line L1 and the cooling determination line L2, the operation mode determination portion 63 determines the operation mode to be switched to the air-blowing mode. In other words, when the temperature difference between the target temperature Tao and the exterior air temperature Tam is less than a predetermined value, the operation mode is determined to be switched to the air-blowing mode.

When the temperature is within a range (the heating range) in which Tam is lower than the heating determination line L1 and Tao is higher than the heating determination line L1, the operation mode is determined to be switched to the heating mode. When the temperature is within a range (the cooling range) in which Tam is higher than the cooling determination line L2 and Tao is lower than the cooling determination line L2, the operation mode is determined to be switched to the cooling mode.

The air conditioning control unit 60 has a normal control portion (NRCT) 64 which controls the operation of the air conditioning system 20 during the cooling mode or the heating mode. When the operation mode determination portion 63 determines to switch the operation mode to the cooling mode or the heating mode, the normal control portion 64 performs feedback-control on configurational elements of the air conditioning system 20 such that a blown-air temperature reaches the target temperature Tao.

Furthermore, the air conditioning control unit 60 has an air-blowing control portion (VTCT) 65 which controls the operation of the air conditioning system 20 during the air-blowing mode. When the operation mode determination portion 63 determines to switch the operation mode to the air-blowing mode, the air-blowing control portion 65 fixedly controls the interior air/exterior air switching device to be in the exterior air mode, instead of the feedback control by the normal control portion 64. In addition, the air-blowing control portion 65 stops various heaters 10, 27 and the electric compressor 41 and fixedly controls the blower 23 to be in the operating state.

The control provided by the air-blowing control portion 65 is control which suppresses fogging of the window shield 9, only using electric-power of the low voltage battery 7 and without using electric-power of the high voltage battery 2, and which causes the room temperature Tr to get closer to the setting temperature Tset.

Microcomputers having storage media readable by a computer are provided as the battery control unit 3 and the air conditioning control unit 60. The storage medium non-temporarily stores programs readable by a computer. A semiconductor memory or a magnetic disc may be provided as the storage medium. The program is executed by the control unit and causes the control unit to function as the device described in this specification. In addition, the program causes the control unit to function such that the control unit executes a control method described in this specification. Means provided by the control unit can also be referred to as a functional block or a functional module for achieving a predetermined function.

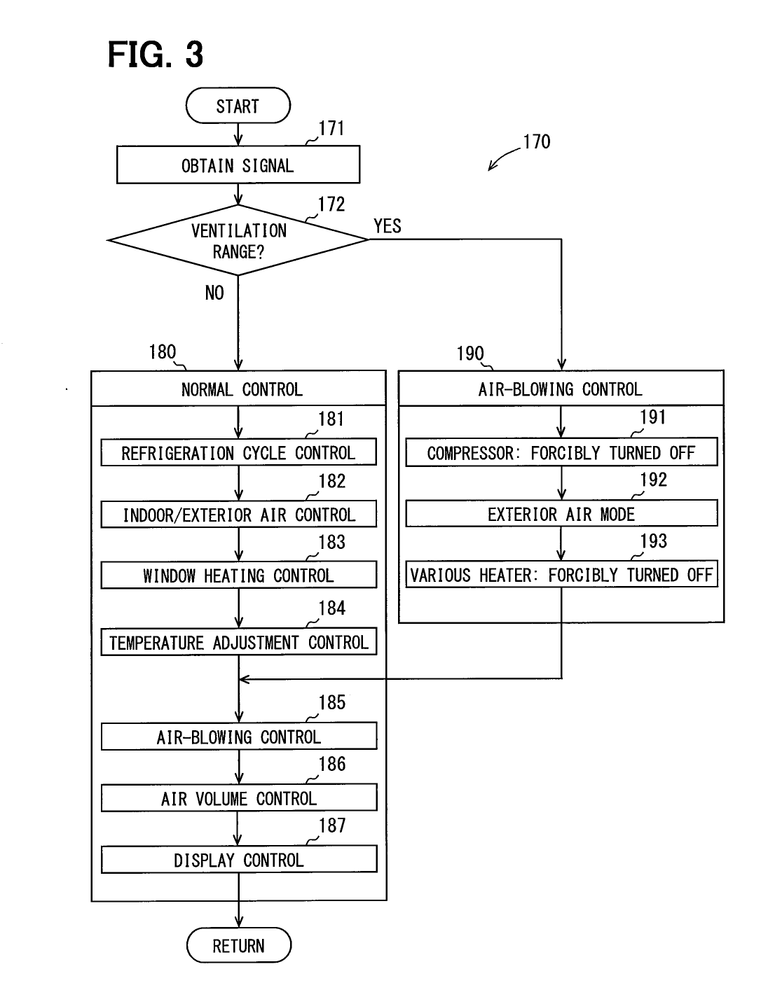

FIG. 3 illustrates an air conditioning process 170 for executing the normal control and the air-blowing control. The air conditioning control unit 60 repeatedly executes the air conditioning process 170 with a predetermined period.

The air conditioning control unit 60 obtains, in Step 171, information necessary for the air conditioning process 170. The air conditioning control unit 60 obtains various physical quantities, for example, the setting temperature Tset, the exterior air temperature Tam, the room temperature Tr, the relative humidity RHW, and the amount of insolation. The air conditioning control unit 60 calculates the optimal value of the target temperature Tao, based on the obtained values.

In Step 172, it is determined, using the map of FIG. 2, that the operation mode should be switched to the heating mode, the air-blowing mode, or the cooling mode, based on the target temperature Tao and the exterior air temperature Tam. When the operation mode is determined to be switched to the air-blowing mode, the process proceeds to Step 190 and, when the operation mode is determined to be switched to the heating mode or the cooling mode, the process proceeds to Step 180.

Step 180 provides the normal control portion 64 and the air conditioning control unit 60 executes the normal control in Step 180.

The air conditioning control unit 60 controls, in Step 181, the refrigeration circuit 40 including the electric compressor 41, in accordance with the determination result from the operation mode determination portion 63. In other words, when an amount of available electric-power, which is allowed by the battery control unit 3, is adequate for operating the electric compressor 41, the electric compressor 41 is operated at the rotational speed according to the target temperature Tao.

When the determination result is the heating mode, the on/off valve 47 is operated to cause refrigerant to flow through the decompressor 46, and the switch valve 49 is operated to cause refrigerant to flow while bypassing both the decompressor 48 and the cooling heat exchanger 24. Accordingly, in the heating mode, dehumidification by the cooling heat exchanger 24 (a cooler) is prevented and heating is performed by heating blown air using heaters, such as the heating heat exchanger 26 and various heaters 27. When the normal control portion 63 performs control (non-dehumidification heating control) in which dehumidification is prevented and heating is performed as described above, the normal control portion 63 may correspond to a non-dehumidification heating control portion.

On the contrary, when the determination result is the cooling mode, the on/off valve 47 is operated to cause refrigerant to flow while bypassing the decompressor 46, and the switch valve 49 is operated to cause refrigerant to flow in both the decompressor 48 and the cooling heat exchanger 24. Accordingly, regardless of the heating mode and the cooling mode, refrigerant flows through the heating heat exchanger 26 (an interior heat exchanger). In other words, in the refrigeration circuit 40, a refrigerant flow passage bypassing the heating heat exchanger 26 is not provided and refrigerant continuously flows through the heating heat exchanger 26.

The air conditioning control unit 60 controls, in Step 182, the interior air/exterior air switching device 22. In this case, the interior air or the exterior air is selected in accordance with the request from a user. Furthermore, when an automatic control is requested, the interior air/exterior air switching device 22 is controlled to suppress fogging of the window shield 9, which is indicated by the signal from the dew condensation sensor 62. Specifically, regardless of the cooling mode and the heating mode, the interior air/exterior air switching device 22 is set to the interior air mode, on the condition that the generation of fogging in the window shield 9 is not detected. However, when the generation of fogging is detected, the interior air/exterior air switching device 22 is set to the exterior air mode. The generation of fogging is detected by a signal from the dew condensation sensor 62.

The air conditioning control unit 60 executes, in Step 183, a window heating control for heating the window shield 9. In this case, the window heater 10 which can directly heat the window shield 9 is controlled. For example, when the generation of fogging is detected, the electric-power is supplied to the window heater 10, and thus the window heater 10 heats the window shield 9. When the generation of fogging is not detected, the power supply to the window heater 10 is cut off.

The air conditioning control unit 60 performs, in Step 184, control in which the temperature (the temperature of the blown air) of air blown from the blowout openings 31a, 31b, and 31c is controlled by adjusting degree of heating of air flowing through the air conditioning unit 21 using the heating heat exchanger 26. In this case, the air mix damper 25 is controlled. Furthermore, the electric heater 27 is controlled. In addition, the flow rate of a medium flowing through the heating medium heat exchanger 28 is controlled. Since Step 184 is executed, the blown-air temperature is adjusted to the target temperature Tao and, further, the room temperature Tr is controlled to reach the setting temperature Tset. As a result, a comfortable temperature condition is provided.

The air conditioning control unit 60 controls, in Step 185, the air-blowing mode switch device 31. In this case, the air-blowing mode is selected to provide a comfortable condition to a user. The air conditioning control unit 60 controls the air-blowing mode switch device 31 to achieve the air-blowing mode requested by a user. Furthermore, when the automatic control is requested, the air conditioning control unit 60 automatically selects an appropriate air-blowing mode in accordance with the temperature of the blown air and can control the air-blowing mode switch device 31 to achieve the selected air-blowing mode.

The air conditioning control unit 60 controls, in Step 186, the blower 23. The air conditioning control unit 60 controls the blower 23 to achieve the air volume requested by a user. In addition, when the automatic control is requested, the air conditioning control unit 60 can automatically control the blower 23 to achieve the air volume necessary for controlling the room temperature Tr to the setting temperature Tset.

The air conditioning control unit 60 controls, in Step 187, a display device of the air conditioning system 20. The air conditioning control unit 60 causes, for example, the operation panel 61 to display an air conditioning state, such as the current room temperature Tr, the setting temperature Tset, the air volume, and the air-blowing mode.

Step 190 provides the air-blowing control portion 65 and the air conditioning control unit 60 executes air-blowing control in Step 190. The air-blowing control portion 65 may be used as an example of a first blowing control portion. When the temperature difference between the target temperature Tao of air blown from the blowout opening and the exterior air temperature (Tam) is less than the predetermined value, the first layer wind control portion causes the blower 23 to be operated in a state where the electric compressor 41 is stopped and the first layer wind control portion controls the operation of the interior/exterior air adjustment device such that at least air including exterior air is blown into the vehicle cabin.

The air conditioning control unit 60 forcibly stops the electric compressor 41 in Step 191 and causes a stopped (turned-off) state to be fixed. In this case, the electric compressor 41 is completely stopped. The electric compressor 41 is fixed to a stopped state, without depending on the signal from the dew condensation sensor 62. The electric compressor 41 is continuously held in the stopped state, and thus discharge from the high voltage battery 2 is suppressed. As a result, the electric-power of the high voltage battery 2 can be used for the electric motor 4 for travel.

The air conditioning control unit 60 causes, in Step 192, the interior air/exterior air switching device 22 to be fixed to the exterior air mode. Accordingly, the air conditioning unit 21 introduces exterior air of which the humidity is relatively low and the temperature difference relative to the target temperature Tao is less than the predetermined value. Various heaters 10, 27 are forcibly stopped in Step 193 and the stopped (a turned-off) state is fixed. Accordingly, the electric-power is prevented from being discharged from the high voltage battery 2, and thus the electric-power of the high voltage battery 2 can be used for the electric motor 4 for travel. Furthermore, the air conditioning unit 21 in the air-blowing mode suppresses fogging of the window shield 9 by supplying exterior air, which is air of relatively low humidity, into the vehicle cabin.

The air conditioning control unit 60 causes, in Step 193, the window heater 10 to be fixed to a turned-on state. The window heater 10 is fixed to the operating state without depending on the signal from the dew condensation sensor 62. Accordingly, the window shield 9 is continuously heated. As a result, fogging of the window shield 9 is suppressed.

Step 193 is performed, and then the process proceeds to Step 185.

When Step 190 is performed, and then Steps 185 to 187 are performed, the control suitable for the state in which the electric compressor 41 is stopped is executed. The air-blowing mode switch device 31 is controlled in Step 185, on the condition that the cooling effect cannot be obtained by the cooling heat exchanger 24 and the heating effect cannot be obtained by both the heating heat exchanger 26 and various heaters 10, 27.

According to the present embodiment, in an intermediary state in which the target temperature Tao reaches a temperature close to the exterior air temperature Tam, the blower 23 is operated in the exterior air mode, in a state where the electric compressor 41 is stopped. Thus, a reduction in electric-power consumption can be achieved and air-conditioning can be performed by blowing air with a temperature close to the target temperature Tao into the vehicle cabin. Accordingly, the power consumption of the high voltage battery 2 is suppressed. In addition, the mode is fixed to the exterior air mode, and thus fogging of the window shield 9 can be suppressed.

In the present embodiment, the non-dehumidification heating control is performed in the heating mode. However, on the contrary, when the dehumidification by the cooling heat exchanger 24 is performed in the heating mode, condensed water would adhere to the cooling heat exchanger 24 in the heating mode. Accordingly, when the heating mode is switched to, for example, the air-blowing mode in accordance with a decrease in the target temperature Tao, the condensed water generated in the air-blowing mode would be evaporated in the air-blowing mode. As a result, odor components would be blown in accordance with evaporation and flow into the vehicle cabin through the blowout openings 31a, 31b, and 31c. As a result, there would be a problem in that a passenger senses a stench.

In this embodiment placing a focus on this point, the non-dehumidification heating control in which dehumidification is prevented in the heating mode is performed. Accordingly, the mode switch from the heating mode to the air-blowing mode is prevented in a state where condensed water adheres to the heat exchanger. As a result, the odor problem as a result of evaporation of the condensed water can be solved.

In the present embodiment, the refrigeration circuit 40 has a configuration in which the cooling heat exchanger 24 and the exterior heat exchanger 45 are connected in series and refrigerant continuously flows through the heating heat exchanger 26. When the refrigeration circuit 40 having the configuration described above performs a dehumidification heating operation, a necessary amount of refrigerant may increase and the discharge capacity required for the electric compressor 41 may also increase. On the contrary, in a case of a refrigeration circuit in which the cooling heat exchanger 24 and the exterior heat exchanger 45 are connected in parallel, the amount of refrigerant would be reduced. In this case, however, it is necessary to provide a flow passage which connects the cooling heat exchanger 24 and the exterior heat exchanger 45 in parallel and it is necessary to provide a switching valve for performing switching the flow of the refrigerant to the parallel flow passage. As a result, this would lead to an increase in costs.

In this embodiment, the non-dehumidification heating control is performed to solve the odor problem, as described above. Thus, the advantage (that is, the switching valve is not necessary) obtained, without the parallel connection, using the series connection between the cooling heat exchanger 24 and the exterior heat exchanger 45 is greater than the advantage (which is a refrigerant amount reduction effect) obtained using the parallel connection. In the present embodiment placing a focus on this point, the refrigeration circuit 40 in which the cooling heat exchanger 24 and the exterior heat exchanger 45 are connected in series is used, and thus the advantage described above is appropriately exerted.

### Second Embodiment

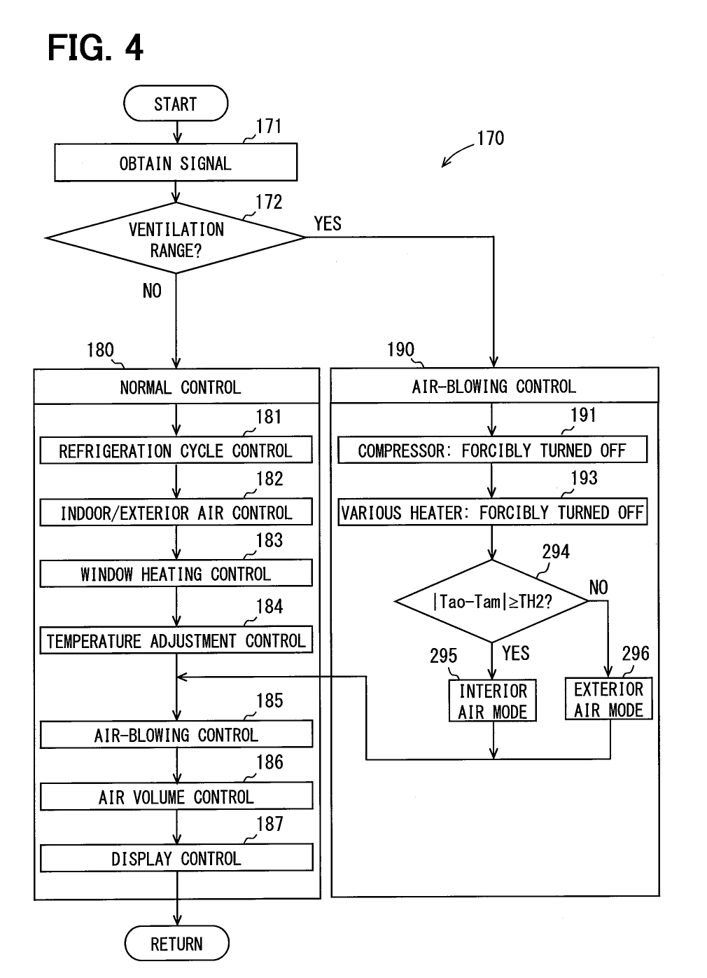

FIG. 4 illustrates air-blowing control according to a second embodiment. The same configuration as those in FIGS. 1 and 2 is also applied to this embodiment. In the present embodiment, Step 192 in the preceding embodiment is eliminated and Steps 294, 295, 296 are added to follow Step 193.

In Step 294, it is determined whether the temperature difference between the target temperature Tao and the exterior air temperature Tam is equal to or greater than a predetermined value TH2. The air conditioning control unit 60 controls the operation of the interior air/exterior air switching device 22 such that, when |Tao−Tam|≧TH2 is satisfied, the interior air mode is set in Step 295 and, when |Tao−Tam|<|<TH2 is satisfied, the exterior air mode is set in Step 296.

The interior air/exterior air switching device 22 has a configuration in which interior air is partially mixed even in the exterior air mode, as described above. Accordingly, exterior air is partially mixed even in the interior air mode by Step 295 and interior air is partially mixed even in the exterior air mode by Step 296. In short, when |Tao−Tam|≧TH2 is satisfied, an amount of the exterior air is reduced, compared to a case where |Tao−Tam|<TH2 is satisfied.

Here, in the map of FIG. 2 used for the mode determination in Step 172, when the temperature difference between the target temperature Tao and the exterior air temperature Tam is less than a predetermined value (for example, 5° C.), it is determined to perform the air-blowing mode. In this case, the predetermined value used for the determination is referred to as a first predetermined value TH1 and the predetermined value TH2 used for the interior air/exterior air determination in Step 294 is referred to as a second predetermined value. The second predetermined value TH2 is set to a value smaller than the first predetermined value.

Accordingly, air-blowing of the interior air mode is performed in both a range (an interior air blowing range) between the one dot chain line L1a and the solid line L1 and a range (the interior air blowing range) between the one dot chain line L2a and the solid line L2, out of the range (the air-blowing range) between the solid lines L1 and L2 in FIG. 2. In other words, in a state where the electric compressor 41 is stopped, the mode is set to the interior air mode and the blower 23 is operated. Meanwhile, in the air-blowing range aside from the interior air blowing range, air-blowing is performed in the exterior air mode, similarly to the air-blowing control of the first embodiment as described above. A portion of the air conditioning control unit 60 which performs the control operation of Step 295 may be used as an example of a second air-blowing control portion. When the temperature difference between the target temperature Tao and the exterior air temperature Tam is less than the second predetermined value, the second air-blowing control portion controls the operation of the interior/exterior air adjustment device such that the blower 23 is operated in a state where the electric compressor 41 is stopped and an amount of the exterior air contained in the blown air is reduced.

Here, an aspect of the heating operation will be described. First, in a starting period of the air-conditioning operation, when the room temperature Tr is lower than the setting temperature Tset and the target temperature Tao is higher than the exterior air temperature Tam, the air-conditioning operation is operated in the heating mode. Subsequently, when the room temperature Tr is raised in accordance with the time elapsed in the heating-mode operation and the room temperature Tr gets closer to the setting temperature Tset, the target temperature Tao is lowered. As a result, |Tao−Tam|<TH1 is satisfied, and thus the operation is switched to the air-blowing mode operation (see arrow Y1 in FIG. 2). In this case, even in a state where the target temperature Tao is lowered and |Tao−Tam|<TH2 is satisfied, if the air-blowing control using the exterior air mode is continuously performed, contrary to this embodiment, exterior air with a temperature lower than the setting temperature Tset would be blown to the vehicle cabin. Accordingly, the room temperature Tr is lowered. As a result, the target temperature Tao is raised and |Tao−Tam|≧TH1 is satisfied, and thus the operation is switched to the heating-mode operation.

In other words, switching between the heating mode and the air-blowing mode is repeatedly performed and turning-on/off of the electric compressor is frequently performed. As a result, there would be a concern that a passenger may feel an unfavorable air-conditioning feeling and wear of each part may increase.

In response to this concern, in the present embodiment, air-blowing in the interior air mode is performed in a period from the time at which |Tao−Tam|<TH1 is satisfied to the time at which |Tao−Tam|<TH2 is satisfied. Thus, when the heating mode is switched to the interior air blowing mode, a decrease in the room temperature Tr is suppressed. As a result, frequent turning-on/off of the electric compressor 41, which results from repetitive switching between the heating mode and the air-blowing mode, can be suppressed.

If the interior air blowing range is expanded over the entirety of the air-blowing range, and thus the air-blowing range is eliminated, the humidity of the vehicle cabin would increase. Accordingly, the window shield 9 would be likely to be fogged. However, in the present embodiment, in a state where the heating-mode operation is operated, when the temperature is within the range in which |Tao−Tam|<TH2 is satisfied, the heating mode is switched to the air-blowing mode in which exterior air with relatively low humidity is blown. Thus, fogging can be removed.

The aspect of the heating operation is explained in the above description. However, the aspect is also similar to a case of the cooling operation. When the cooling mode is switched to the air-blowing mode (see arrow Y2 in FIG. 2), if the air-blowing control using the exterior air mode is continuously performed at the time at which |Tao−Tam|<TH1 is satisfied, exterior air of the temperature higher than the setting temperature Tset would be blown to the vehicle cabin. Accordingly, the room temperature Tr increases. As a result, |Tao−Tam|≧TH1 is satisfied, and thus the operation is switched to the cooling-mode operation.

In other words, switching between the cooling mode and the air-blowing mode is repeatedly performed and turning-on/off of the electric compressor is frequently performed. As a result, there is a concern that a passenger may feel an unfavorable air-conditioning feeling and wear of each part may be promoted.

In response to this concern, in the present embodiment, air-blowing in the interior air mode is performed in a period from the time at which |Tao−Tam|<TH1 is satisfied to the time at which |Tao−Tam|<TH2 is satisfied. Thus, when |Tao−Tam|<TH1 is satisfied, and thus the mode is switched from the cooling mode, an increase in the room temperature Tr is suppressed. As a result, frequent switching between the cooling mode and the air-blowing mode can be suppressed.

The interior air/exterior air switching device 22 has a configuration in which interior air is partially mixed even in the exterior air mode. Thus, when the heating mode is switched to the air-blowing mode, a decrease in the temperature of blown air, which results from a mode change to the exterior air mode, can be suppressed by mixing interior air. As a result, the above-described concern that “the heating mode and the air-blowing mode are repeatedly switched” can be suppressed.

### Third Embodiment

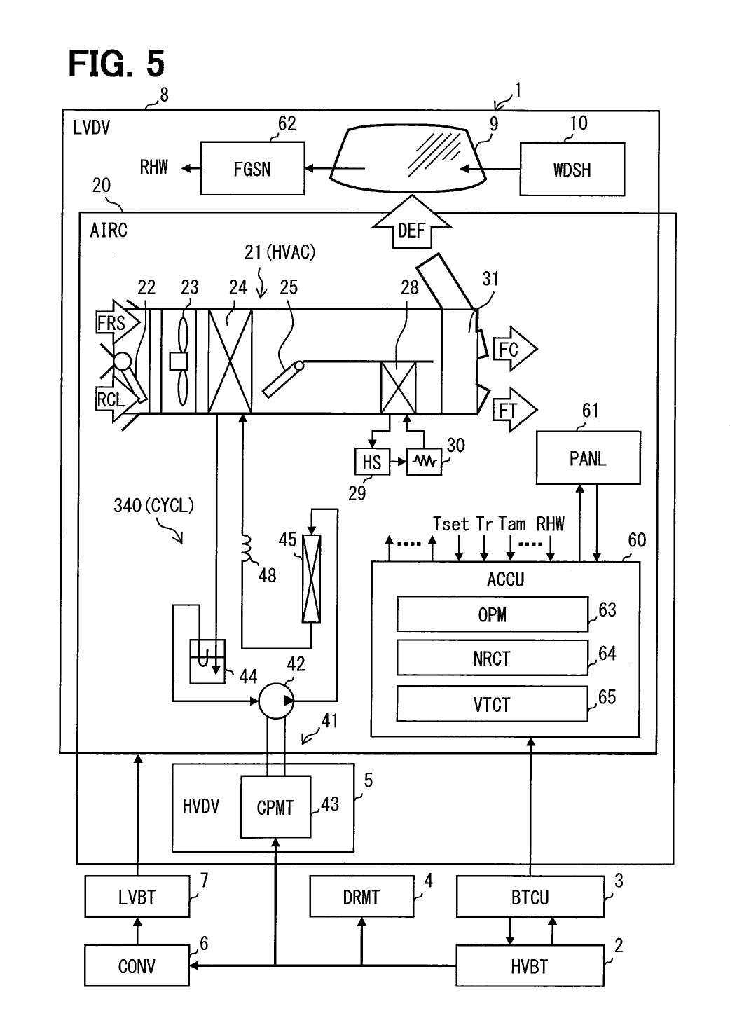

FIG. 5 illustrates an electric vehicle system according to a third embodiment. In the present embodiment, a refrigeration circuit 340 is a cooler cycle in which only a cooling operation is available. Even in this embodiment, the same operation effects as those in the embodiments described above can be obtained.

A heating medium heat exchanger 28 which heats the blown air, using hot water, is provided in the present embodiment. The heating medium heat exchanger 28 (a heating device) heats air, which flows through the air conditioning unit 21 and is blown into the vehicle cabin, using a cooling medium for cooling a device (HS) 29, as a heat source, mounted on a vehicle. The heating medium heat exchanger 28 is disposed in a state where the heating medium heat exchanger 28 heats at least a portion of air flowing through the air conditioning unit 21. The heating medium heat exchanger 28 is a portion of a cooling system for cooling the device 29. The cooling medium is a heat transfer fluid, such as water. The device 29 is a device generating heat and is provided by, for example, an electric device, an inverter circuit, or an internal combustion engine mounted on the vehicle.

When the medium circulates, the heating medium heat exchanger 28 can heat the air, using heat supplied from the device 29. Accordingly, the heating medium heat exchanger 28 can be provided, by itself, as one of the air heaters. The heating medium heat exchanger 28 is an air heating element which can perform a heating function even in a state where the electric compressor 41 is stopped. The heating medium heat exchanger 28 is one of the heating elements which can indirectly heat the window shield 9. The heating medium heat exchanger 28 indirectly suppresses fogging of the window shield 9 by increasing a temperature of the window shield 9.

The cooling system including the heating medium heat exchanger 28 has a medium heater 30 for electrically heating the cooling medium. The medium heater 30 heats air flowing through the air conditioning unit 21, using electric-power, through the heating medium heat exchanger 28. The medium heater 30 is disposed in a state where the medium heater 30 indirectly heats at least a portion of air flowing through the air conditioning unit 21. An electric heater element is provided as the medium heater 30. A heater element, referred to as a Positive Temperature Coefficient (PTC) heater, is provided as the medium heater 30. The medium heater 30 is one of the high voltage devices 5. The medium heater 30 receives the electric-power from the high voltage battery 2. It is preferable that, when the air-blowing mode is performed, the medium heater 30 be turned off to achieve a reduction in electric-power consumption.

Here, if the electric heater directly heats the blown air, contrary to the present embodiment, a temperature of the blown air would decrease immediately after supplying of electric-power to the electric heater is turned off. However, in the present embodiment, the blown air is heated using heat transport fluid, such as coolant in an inverter circuit, as a heating medium. Accordingly, heat mass of the heating medium allows the temperature of the blown air to be prevented from decreasing immediately after supplying of electric-power to the medium heater 30 is turned off. Thus, when the medium heater 30 is turned off in accordance with a mode switch from the heating mode to the air-blowing mode, it is possible to prevent a temperature of the blown air from immediately decreasing. As a result, change in temperature of the blown air is reduced, and thus it is possible to achieve an improvement in air-conditioning feeling.

According to the present embodiment, the effect of a reduction in electric-power consumption can be significantly exerted, as described below. In other words, when heating is performed by the electric heater 30, as described in the present embodiment, the electric-power consumption is significantly increased, compared to a case where heating is performed by the refrigeration circuit 40 as illustrated in FIG. 1. This results from the fact that COP (which is energy consumption efficiency) of the electric heater 30 is significantly lower than COP of a heat pump. However, in the present embodiment, since the medium heater 30 is turned off during the air-blowing mode, a disadvantage that electric-power consumption is increased due to low COP can be suppressed. As a result, the effect of a reduction in electric-power consumption is significantly exerted. In the present embodiment, it is also preferable that the non-dehumidification heating control be performed in the heating mode, similarly to the first embodiment described above. In this case, the mode switch from the heating mode to the air-blowing mode is prevented with condensed water adhering to the heat exchanger, similarly to the first embodiment described above. As a result, the odor problem relative to evaporation of the condensed water can be solved during the operation using the air-blowing mode.

### Other Embodiments

Hereinbefore, preferred embodiments of the disclosure disclosed above are described. However, the disclosure is not limited to the embodiments described above and can be realized in various modifications. The configurations of the embodiments described above are only exemplifications and are not intended to limit the technical scope of the disclosure disclosed above.

When the interior air blowing range is set as illustrated in FIG. 2, for example, switching between the interior air blowing range and the other range (the air-blowing range, the heating range, or the cooling range) may be determined based on the room temperature Tr, instead of the exterior air temperature Tam. Furthermore, switching between the interior air blowing range and the other range may be determined based on the setting temperature Tset, instead of the target temperature Tao.

When the interior air blowing range is not set, switching between the air-blowing range and the other range (the heating range or the cooling range) may be determined based on the setting temperature Tset, instead of the target temperature Tao.

It may be configured in a way that a user can operate switching an operation between an ecology mode operation and a normal mode operation and, when the ecology mode is selected, the air-blowing mode may be performed as illustrated in FIG. 2. In addition, when the normal mode is selected, the air-blowing mode may be prevented and the electric compressor 41 may be operated over the entire range in FIG. 2.

Means and functions provided by the control unit can be provided by, for example, only software, only hardware, or a combination thereof. The control unit may be constituted by, for example, an analog circuit.

In the embodiments described above, a heat pump cycle is provided by the refrigeration circuit 40 having two interior heat exchangers 24, 26. However, instead of the heat pump cycle described above, a heat pump cycle which has a single interior heat exchanger and can switch the function of the single interior heat exchanger between cooling and heating may be applied. An inverting type heat pump cycle which can switch an operation mode between an operation mode in which the interior heat exchanger is used as an evaporator and an operation mode in which the interior heat exchanger is used as a radiator, for example, can be applied.

In the embodiment described above, when the heating mode or the cooling mode is performed, for example, the mode is fixed to the interior air mode, without depending on the signal from the dew condensation sensor 62. However, in the heating mode or the cooling mode, when fogging is detected by the dew condensation sensor 62, fogging may be eliminated by switching the mode to the exterior air mode. In the second embodiment described above, even in a state where the air-blowing mode is operated in the interior air mode, the interior air mode may be switched to the exterior air mode when fogging is detected by the dew condensation sensor 62.

In each embodiment described above, when the air-blowing mode is performed, various heaters 10, 27, 30 are fixed to the stopped state, without depending on the signal from the dew condensation sensor 62. However, when fogging is detected by the dew condensation sensor 62, fogging may be removed by turning on the various heaters 10, 27, 30.

The heating medium heat exchanger 28, the device 29, and the medium heater 30 illustrated in FIG. 5 may be used in combination with the air conditioning system illustrated in FIG. 1 and the heating heat exchanger 26, the electric heater 27, and the heating medium heat exchanger 28 may be used as air heating means.

In each embodiment described above, interior air is partially mixed in the exterior air mode and the exterior air is partially mixed in the interior air mode. However, only exterior air may be introduced in the exterior air mode and only interior air may be introduced in the interior air mode.

What is claimed is:

1. A vehicle air-conditioning device comprising:
a blower blowing air into a vehicle cabin through blowout openings;
a refrigeration circuit through which refrigerant is circulated by an electric compressor;
an interior heat exchanger disposed in the refrigeration circuit and exchanging heat between the refrigerant and a blown air, which is air that is blown by the blower;
an interior/exterior air adjustment device adjusting a ratio of interior air and exterior air contained within the blown air; and
a first blowing control portion controlling the electric compressor to stop, controlling the blower to operate, and controlling the interior/exterior air adjustment device such that air that is blown into the vehicle cabin includes at least exterior air, when a temperature difference between a target temperature of air that is blown through the blowout opening and an exterior air temperature is less than a predetermined value.

2. The vehicle air-conditioning device according to claim 1, wherein
the interior heat exchanger has a cooler that cools the blown air and a heater that heats the blown air, and
the vehicle air-conditioning device further comprises
a non-dehumidification heating control portion preventing the cooler from dehumidifying the blown air and controlling the heater to heat the blown air, when the target temperature is higher than the exterior air temperature and the temperature difference is equal to or greater than the predetermined value.

3. The vehicle air-conditioning device according to claim 1, wherein
the predetermined value is defined as a first predetermined value, and
the vehicle air-conditioning device further comprises
a second air-blowing control portion controlling the electric compressor to stop, controlling the blower to operate, and controlling the interior/exterior air adjustment device such that an amount of the exterior air included in the blown air decreases, when the temperature difference between the target temperature and the exterior air temperature is equal to or greater than a second predetermined value, which is less than the first predetermined value.

4. The vehicle air-conditioning device according to claim 1, wherein
an exterior heat exchanger is provided in the refrigeration circuit, the exterior heat exchanger exchanging heat between the refrigerant and exterior air, and
the refrigerant is circulated by the electric compressor to continuously flow through the exterior heat exchanger in the refrigeration circuit.

5. The vehicle air-conditioning device according to claim 4, further comprising:
a heating device provided separately from the refrigeration circuit and heating the blown air with hot water.
